(19) United States
(12) Patent Application Publication
(10) Pub. No.: US 2002/0026319 A1
(43) Pub. Date: Feb. 28, 2002

(54) Service mediating apparatus

(75) Inventors: Manabu Niie, Sagamihara (JP); Makoto Shioya, Tokyo (JP); Seiji Ukai, Tokyo (JP); Toshihiro Kujirai, Kokubunji (JP); Yoshito Nejime, Koganei (JP); Tadashi Kamiwaki, Tokaimura (JP); Toshiichirou Sasaki, Iwaki (JP); Naoyuki Koga, Atsugi (JP)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Hitachi, Ltd., Tokyo (JP)

(21) Appl. No.: 09/803,209

(22) Filed: Mar. 9, 2001

(30) Foreign Application Priority Data
Aug. 31, 2000 (JP) 2000-268371

(51) Int. Cl. G10L 11/00; G10L 21/00

(52) U.S. Cl. 704/270

(57) ABSTRACT

The present invention provides a system in which a service providing apparatus on the Internet efficiently provides service including provision of information corresponding to a voice input. The system is configured as follows.

A service requesting apparatus 300 receives a voice indicating a service request from a user, and transmits voice data corresponding to the received voice to a service mediating apparatus 100 through a network 1. Based on the voice input from the user, the service mediating apparatus 100 specifies a speech recognition engine which is to recognize a voice. A service providing apparatus then performs a process according to a request recognized by the specified speech recognition engine.

### BACKGROUND OF THE INVENTION

The present invention relates to a technique for mediating provision of information, service, etc. through a network. More particularly, the present invention relates to a mediation process employed in a case in which the format of input data (such as voice or image) from a client apparatus (service requesting apparatus) is different from that directly used by the server apparatus (service providing apparatus) to process information for providing service. It should be noted that a client apparatus according to the present invention can be mounted on a vehicle.

Japanese Laid-Open Patent Publication No. 10-271223 (1998) discloses a technique for mediating access to a web site on the Internet and acquisition of information from a web site by use of voice input.

In this prior art technique, a telephone/internet gateway processor 44 carries out such processes as formation of a communication link, data format conversion, and protocol conversion in response to an input spoken instruction to enable access to a web site.

On the other hand, Japanese Laid-Open Patent Publication No. 2000-112610 discloses a prior art technique for speech recognition in which a plurality of recognition methods are handled including speech recognition and image recognition. This technique sends display contents to a recognition apparatus determined based on the “category” entry, which indicates the type of a target recognition apparatus, included in the text description in the display contents.

### SUMMARY OF THE INVENTION

The above prior art technique described in Japanese Laid-Open Patent Publication No. 10-271223 (1998) uses only the telephone/internet gateway processor 44 to process all voice inputs from a plurality of users. However, each speech recognition engine has its own specific field(s) to which it can be suitably applied. Their recognition speed or accuracy considerably varies depending on the contents (field) of what is spoken. For example, a speech recognition engine for the field of patents recognizes a speech (voice) concerning patents at high speed with high accuracy. However, the same speech recognition engine may recognize a speech (voice) on foods only at low speed with reduced accuracy.

This means that the conventional technique, which uses only a single apparatus to recognize speeches (voices) on a plurality of topics, cannot efficiently perform speech recognition and subsequent service provision based on the speech recognition results on a network connected to the Internet to which speeches (voices) on various topics requesting various services are input.

Incidentally, a service requesting apparatus mounted on a vehicle preferably uses voice inputs for requesting a service. This is because use of voice inputs enables even a driver to enter an instruction. On the other hand, it is highly likely that a request sent from a running vehicle must be quickly processed since the position of the user (vehicle) changes every moment. For example, consider a case in which the user has sent an instruction saying, “search for a nearby restaurant”. If it takes a few hours to complete the search, the found restaurant may be located far from the current vehicle position at which the search result has been received even though it is near the position from which the instruction was sent, causing a problem that the system cannot provide appropriate information. Thus, using the same recognition engine for processing all types of requests is highly likely to raise a problem as described above.

In the above technique disclosed in Japanese Laid-Open Patent Publication No. 2000-112610, voice contents and image data can be separately transmitted to a speech recognition apparatus and a gesture recognition apparatus, respectively. However, the technique is not designed to select a speech recognition engine based on the contents of each piece of voice information. Each type of speech recognition engine differs from one another in the types of voice information that they can easily recognize (types of voice information recognized at high speed with high accuracy) and in the types of voice information that they can hardly recognize (types of voice information recognized at low speed with reduced accuracy), depending on the contents of their dictionaries. Since the above conventional technique uses only a first recognition apparatus (speech recognition) 14A to recognize all voice contents, it is not possible to change recognition apparatuses according to voice contents. Thus, it is necessary to use the first recognition apparatus even for voice contents hardly recognizable by the apparatus. That is, only the same speech recognition engine (recognition apparatus) is used for every request as in the case of the prior art technique disclosed in Japanese Laid-Open Patent Publication No. 10-271223 (1998). Furthermore, the above conventional technique disclosed in Japanese Laid-Open Patent Publication No. 2000-112610 does not consider use of speech recognition results for providing/receiving service. Accordingly, the above conventional technique uses the “category” entry included as a text description to specify a target recognition apparatus instead, and does not consider matching of each type of voice information to be recognized with service contents to be provided. As a result, it is not possible to use a speech recognition engine suitable for a service requested by each piece of voice information.

To solve the above problem, the present invention provides a system in which speech recognition is carried out by a speech recognition engine on a network selected according to each service requested by the user or according to voice input. Furthermore, the present invention includes a service mediating apparatus for controlling the system so that the system operates as described above (mediating provision of each service).

In one aspect of the present invention, to specify a speech recognition engine according to each service or according to voice input, the link-target apparatus corresponding to each service requested by the user may store information indicating its corresponding speech recognition engine beforehand.

In order to process a request from a user to provide service, the present invention employs a plurality of computers on a network, each executing its assigned function so as to collectively perform a series of speech recognition operations.

It should be noted that in addition to voice, the types of data entered by the user may include such data as image, whose data format is not used for providing service.

It should be further noted that VXML (Voice extended Markup Language) may be used to indicate the corresponding relationship between each speech recognition engine and each service or each service providing apparatus.

### BRIEF DESCRIPTION OF THE DRAWINGS

FIG. 1 is a diagram showing the entire configuration of a service mediation system according to an embodiment of the present invention;

FIG. 2 is a diagram showing the configuration of a service providing apparatus 200A according to the embodiment;

FIG. 3 is a diagram showing the configuration of a service mediating apparatus 100 according to the embodiment;

FIG. 4 is a diagram showing the configurations of a vehicle 30C and a service requesting apparatus 300C mounted on the vehicle 30C according to the embodiment;

FIG. 5 is a flowchart showing a process flow of the service mediation system according to the embodiment;

FIG. 6 is a flowchart showing process examples at steps 505 and 506 in FIG. 5;

FIG. 7 is a diagram describing the corresponding relationship between each link-target service providing apparatus and each speech recognition engine by use of the VXML description language;

FIG. 8 is a table showing communication protocols employed between the apparatuses;

FIG. 9 is a diagram showing the configuration of a system employing the communication protocols shown in FIG. 8;

FIG. 10 is a diagram showing a table used by the service mediating apparatus 100 to perform service mediation processing;

FIG. 11 is a diagram also describing the corresponding relationship between each link-target service providing apparatus and each speech recognition engine by use of the VXML description language;

FIG. 11 is different from FIG. 7 in that FIG. 11 specifies each speech recognition engine by giving several conditions to be satisfied by the engine instead of directly specifying it; and

FIG. 12 is a flowchart showing another process flow of the service mediation system according to the embodiment. In addition to the steps in FIG. 5, the process flow of FIG. 12 includes a few particular steps in which an operator is involved.

### DESCRIPTION OF THE PREFERRED EMBODIMENTS

An embodiment of the present invention will be described below with reference to accompanying drawings.

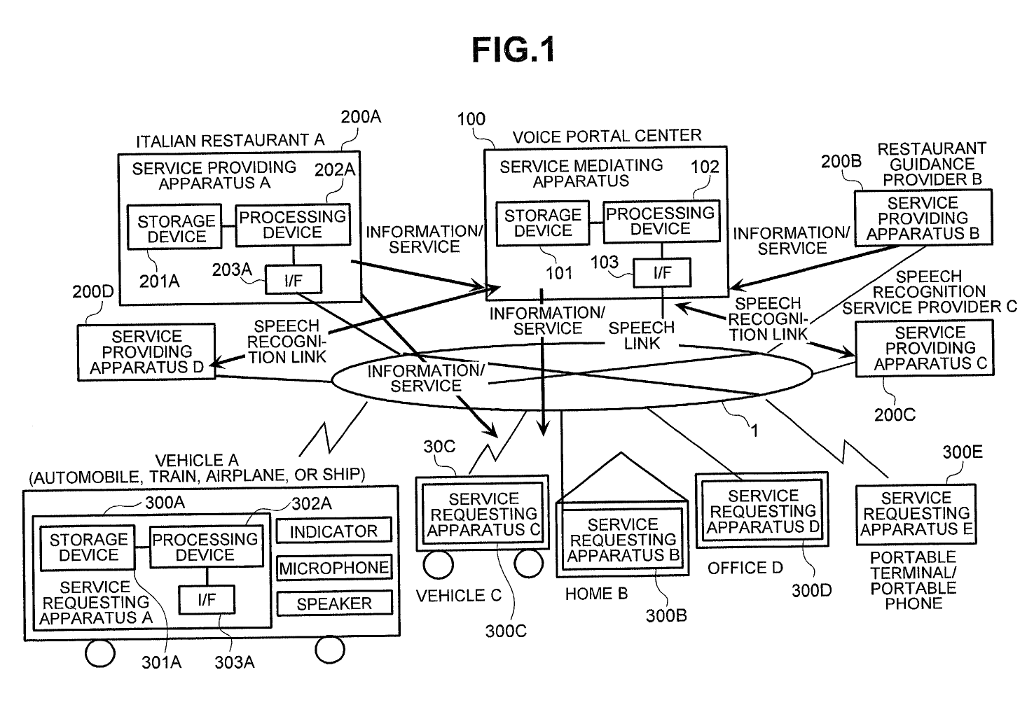

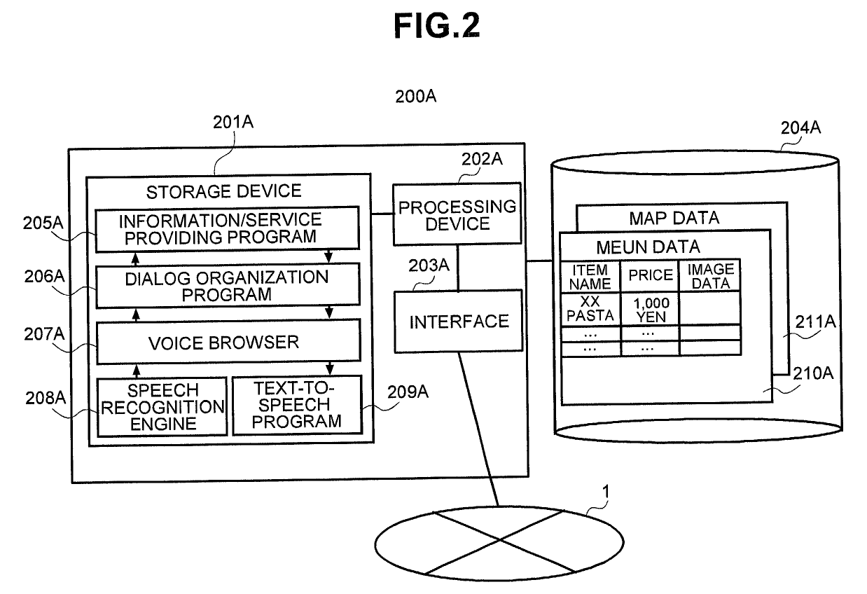

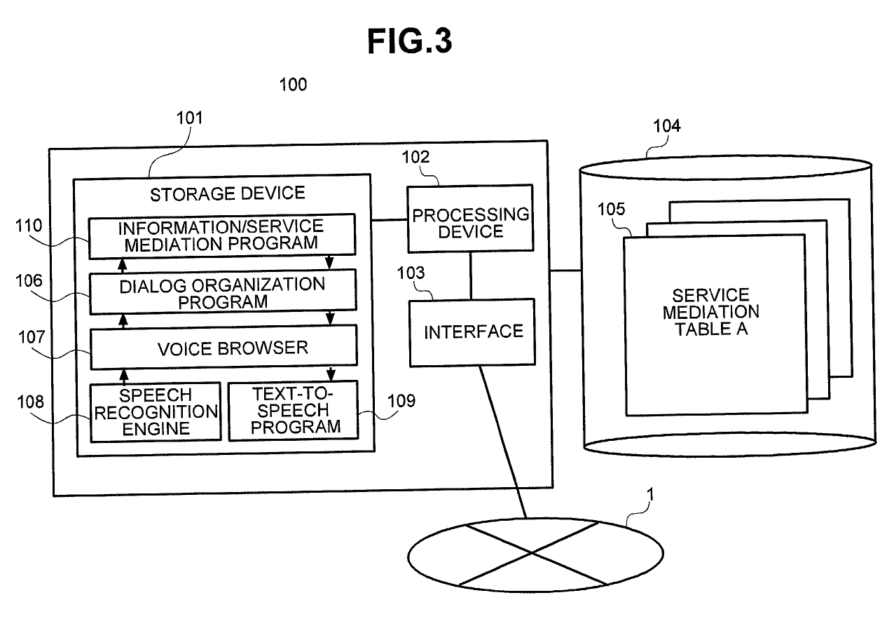

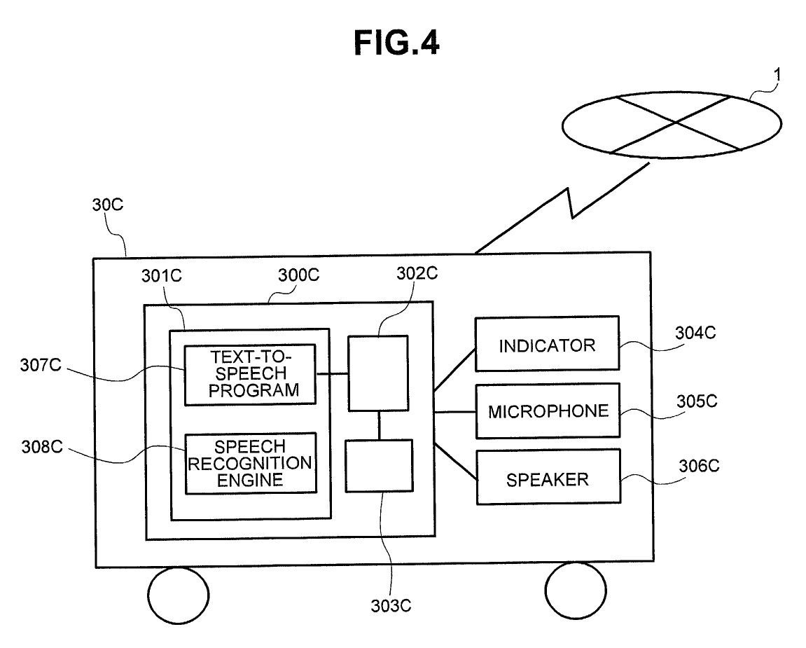

FIG. 1 is a diagram showing the entire configuration of a service mediation system according to the present invention. The system comprises a service mediating apparatus 100, a plurality of service providing apparatuses 200A through 200F, and a plurality of service requesting apparatuses 300A through 300E connected to one another through a network 1. The service requesting apparatuses 300A through 300E each receive a voice input from a user, and the service mediating apparatus 100 relays the request specified by the voice input to one of the service providing apparatuses 200A through 200F corresponding to the requested service. With this arrangement, the user can receive the service (including information) from the one of the service providing apparatuses 200A through 200F.

The above process will be further described in detail below by using an example in which the service providing apparatus 200A is managed by a restaurant A, and the service requesting apparatus 300A is a car navigation apparatus, wherein a search for a restaurant has been requested. The other service providing apparatuses 200B through 200F include computers managed by a movie theater and other amusement facilities. The service providing apparatuses 200A through 200F offer such services as information service on menus, service hours, movies currently available, etc., reservation service, and sales of tickets. Further, the other service requesting apparatuses 300B through 300E include an apparatus mounted on a vehicle, portable phones, and information processing devices such as personal computers, as shown in the figure (the service requesting apparatus 300A is a car navigation apparatus mounted on a vehicle as described above).

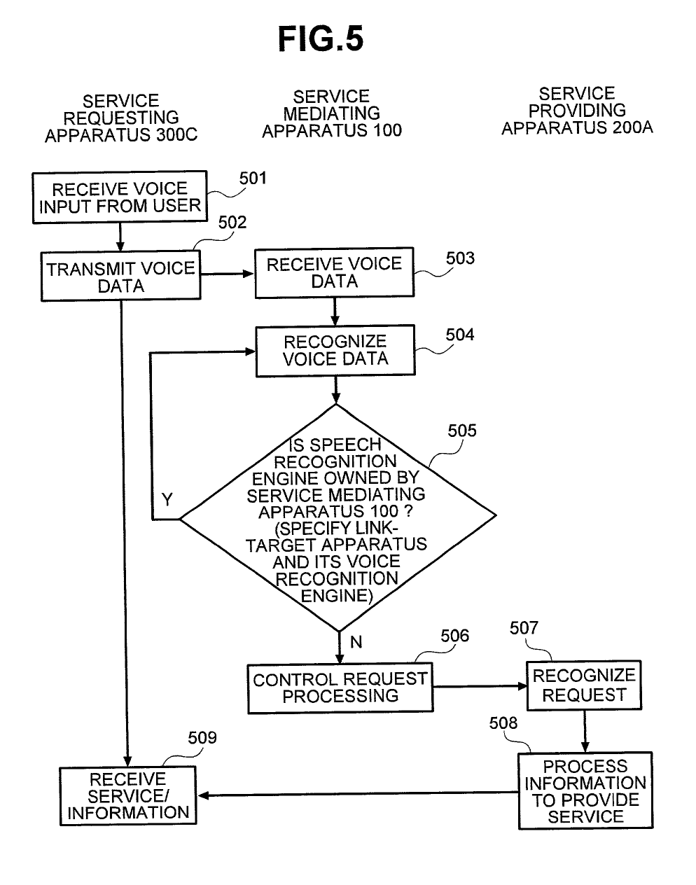

Description will be made of the process flow of the service mediation system with reference to the flowchart of FIG. 5. The following description assumes that the service requesting apparatus 300C is to request a service.

The service requesting apparatus 300C receives a voice input from a user through a microphone 304 in a vehicle 30 at step 501. The user is assumed to have given a request message saying that the user wanted to know a nearby restaurant.

The service requesting apparatus 300C transmits the received voice data to the service mediating apparatus in the voice portal center through the network 1 using an interface 303 according to a program stored in a storage device 301, at step 502. It should be noted that the data transmitted may be the received voice data itself, or both the received voice data and its speech recognition results (whose data format is transformed from that of the received voice data). Further, the types of voice data to be recognized include input voice data itself and data obtained by converting the format of the input voice data (for example, coding the input voice data) so that it is suitable for speech recognition.

When the service requesting apparatus has at least both a voice browser and a dialog organization program (function) as do the service providing apparatuses 200A and 200B, the service requesting apparatus itself may respond to a user request. In the following description of the present embodiment, however, the service mediating apparatus 100 responds to the user request. A user request is responded here by performing processes such as helping narrow down the search according to a program stored in the service requesting apparatus. For example, recognizing the above request message saying, “I want to know a nearby restaurant”, the service requesting apparatus responds to the request by giving the user the question “which type of restaurant, Japanese, Chinese, French, or Italian?” to promote a further data input from the user according to a dialog organization program in order to help process the search request. The question may be given from a speaker 305 according to a text-to-speech program, or indicated on an indicator 306. This process of giving a question to narrow down the search is repeated until the service requesting apparatus cannot process (recognize) a further input or request. The service requesting apparatus then connects with the service mediating apparatus so that the service mediating apparatus can process subsequent inputs or requests (by giving further questions). This connection with the service mediating apparatus can be realized by setting the “link-target apparatus for further request processing” entry stored in the service requesting apparatus and used when the service requesting apparatus cannot process (recognize) an input or request so that the “link-target apparatus for further request processing” entry indicates the service mediating apparatus.

Furthermore, the process of recognizing the inputs may be carried out by the service requesting apparatus and either the service mediating apparatus or the service providing apparatus. In this case, if the service requesting apparatus cannot recognize an input, the service mediating apparatus or the service providing apparatus will recognize it in place of the service requesting apparatus so as to continue the process of recognizing (responding to) the inputs.

It should be noted that the above state of being unable to process (respond to) an input also occurs when the service requesting apparatus has received a request requesting for data which the service requesting apparatus does not have (for example, when the service requesting apparatus has received a question such as “which web site was most popular this week?”). The above state still also occurs when the service requesting apparatus has received a request which the service requesting apparatus cannot recognize because it does not have necessary data (such as words and grammars) for recognizing it.

The types of requests which the service requesting apparatus can process by itself include command execution requests for operating the service requesting apparatus itself and equipment therearound. In the case of a service requesting apparatus in a vehicle, equipment around the service requesting apparatus include equipment mounted on the vehicle, such as an air-conditioner, a wiper, and a radio.

The service requesting apparatuses 300A through 300E may be of types not mountable on vehicles. If the service requesting apparatuses 300A through 300E are mounted on vehicles, they are preferably connected to the network 1 by radio links.

At step 503, using an interface 103, the service mediating apparatus 100 receives voice data saying, “I want to know a nearby restaurant”, transmitted through the network.

The service mediating apparatus 100 recognizes the received voice data using a processing device 102 and a speech recognition program or another type of recognition program at step 504. Since the message (voice data) includes the word “nearby”, the service mediating apparatus 100 performs the process of obtaining the position of the running vehicle 30C. Specifically, for example, the service mediating apparatus 100 performs the following. (1) If the service requesting apparatus 300C is a car navigation system, the service mediating apparatus 100 obtains information on the position of the running vehicle stored in the car navigation system. Or alternatively, (2) the service mediating apparatus 100 requests the user to enter the current position of the vehicle into the service requesting apparatus 300C using a dialog organization program. To be more specific in the case of (2), the service mediating apparatus 100 gives the message “please enter the current position” by voice from a speaker 305 or by an indication on an indicator 306. Whether any restaurant is “near” the vehicle 30C may be determined by checking whether it is located within a predetermined distance from the vehicle 30C. At that time, location information on restaurants stored in a table is used.

On the other hand, a table stored in a storage device 104 is used to search for a restaurant of a desired type. If the category “restaurant” includes a plurality of subcategories, the dialog organization program is set so as to give the user a question such as “which type of restaurant, Japanese, Chinese, French, or Italian?” to promote a further data input from the user. Furthermore, if a plurality of restaurants are registered in a subcategory, the name of each restaurant may be output to the service requesting apparatus 300C one after another. Alternatively, the user may be requested to enter a condition(s) to specify a restaurant of the desired type. For example, the service mediating apparatus 100 stores each restaurant's conditions (price, service hours, taste, availability of parking and its capacity, etc.) beforehand, and promotes the user to enter a condition(s) to be compared with these stored conditions.

At step 505, based on the recognition results of the above input data, the service mediating apparatus 100 determines a speech recognition engine for recognizing voice data sent from the service requesting apparatus 300C.

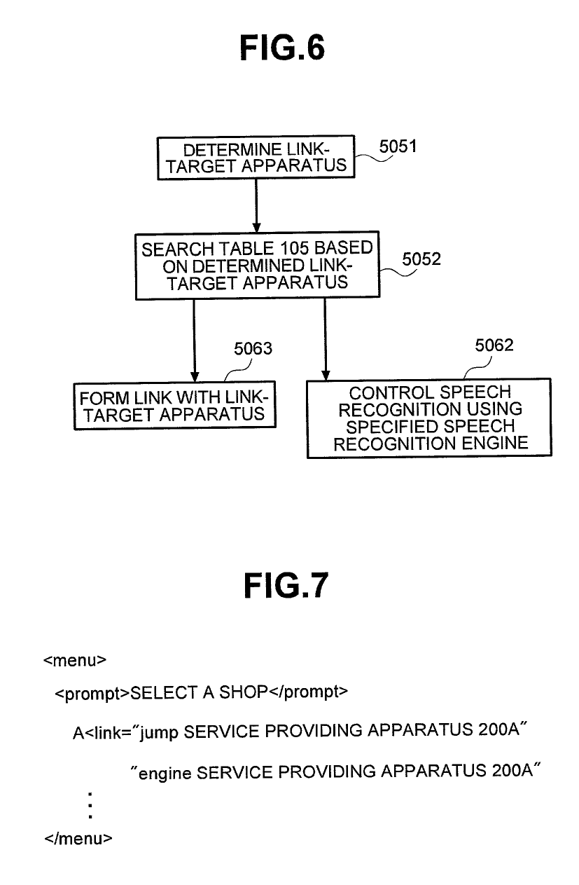

A specific example of step 505 will be described with reference to FIG. 6. Steps 5051 and 5052 in FIG. 6 correspond to step 505.

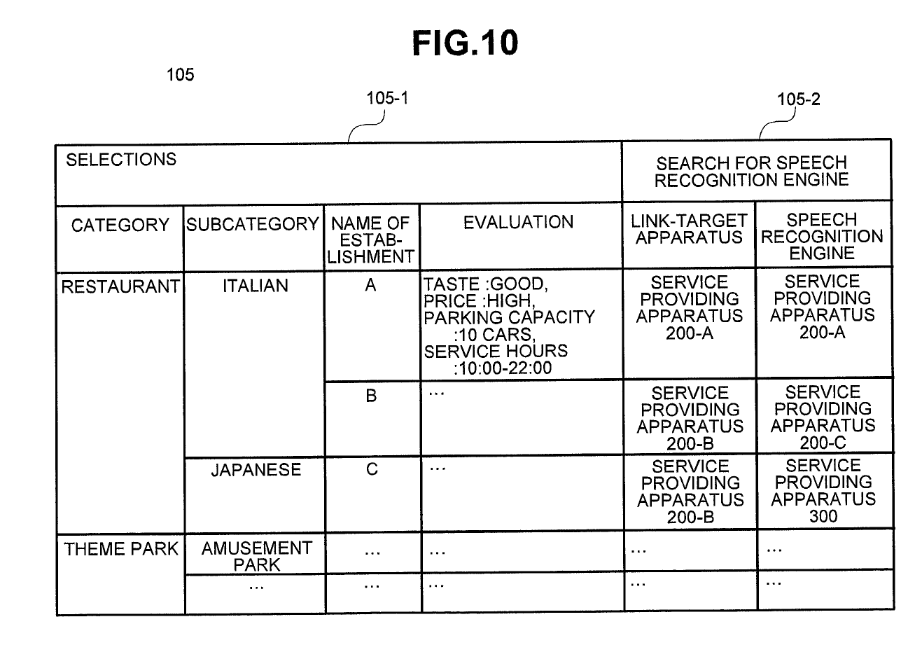

At step 5051, the processing device 102 in the service mediating apparatus 100 searches for a link-target service providing apparatus which is to provide the service requested by the voice data. This search is carried out using a table 105 shown in FIG. 10. That is, the processing device 102 refers to each selection item in the table in search of a matching restaurant. If the category “Italian” is selected in the above inquiry about a desired type of restaurant, restaurants A through D are obtained as a result of the search. The processing device 102 in the service mediating apparatus 100 then inquires about the user's favorite flavoring, price range, desired restaurant location, etc. to specify a restaurant meeting the user's request, and a corresponding service providing apparatus. In this example, it is assumed that the restaurant A has been selected. The service mediating apparatus 100 then specifies a link-target apparatus (e.g., a service providing apparatus) corresponding to the restaurant A using the table. It should be noted that a plurality of restaurants and a plurality of link-target apparatuses may be selected.

By using the table, step 5052 specifies a speech recognition engine corresponding to the specified link-target apparatus. It is also possible to specify the speech recognition engine using its address used to connect with it. A plurality of speech recognition engines, instead of one, may be associated with a link-target apparatus in the table as candidates for a target speech recognition engine. With this arrangement, the candidate speech recognition engines may be narrowed down to one by considering the user's requests concerning such items as charge for using a speech recognition engine and its translation accuracy. The above table may be held by another information processing device on the network.

The speech recognition engine may also be specified using a list written in the VXML description language shown in FIG. 7 instead of a general table.

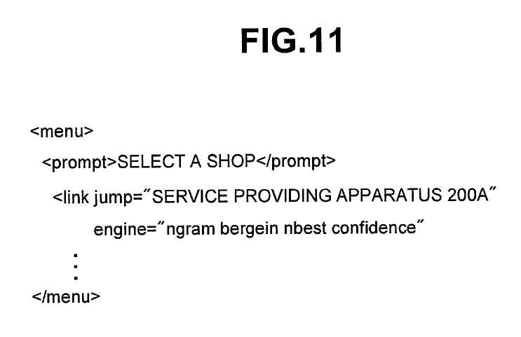

Furthermore, a list written in a specific format shown in FIG. 11 may be used instead of the list written in the VXML description language in FIG. 7. This format specifies each target speech recognition engine using parameters such as “ngram”, “bergein”, “nbest”, and “confidence”, each indicating a specific condition. The parameter “ngram” indicates that a series of words should be recognized; “bergein” indicates that the user can interrupt a text-to-speech process; “nbest” instructs that a plurality of speech recognition result candidates be output; and “confidence” indicates that the degree of reliability of the speech recognition results should be output. That is, FIG. 11 gives conditions to indicate a speech recognition engine capable of recognizing a series of words, accepting an interruption during its voice synthesizing process, outputting a plurality of speech recognition result candidates, and outputting the reliability degree of its speech recognition results.

When specifying a target speech recognition engine using the format shown in FIG. 11, it is possible to select one from either a list of speech recognition engines owned by the link-target service providing apparatus or a list of speech recognition engines owned by a service providing apparatus currently used by the system.

On the other hand, a plurality of speech recognition engines may be selected instead of specifying one so as to recognize the same voice using each of the selected plurality of speech recognition engines. In this case, it is possible to adopt a recognition result obtained fastest (that is, the one obtained from a speech recognition engine having the fastest response characteristic) so as to increase the response speed, or alternatively, it is possible to select the most accurate recognition result from among a plurality of obtained recognition results so as to increase the recognition accuracy.

In this example, the service providing apparatus 200A and a speech recognition engine owned by the apparatus are selected.

After specifying a link-target apparatus and a speech recognition engine, the service mediating apparatus 100 controls the system so that the specified link-target apparatus and speech recognition engine can perform a predetermined process, at step 506.

A specific example of step 506 will be described with reference to FIG. 6. Steps 5061 and 5062 in FIG. 6 correspond to step 506.

Step 5061 changes the linked apparatus (or establishes a link). For example, the service mediating apparatus 100 establishes a connection between the service requesting apparatus 300C and the link-target service providing apparatus A so that the service providing apparatus A can receive voice data from a user.

Step 5062 controls the system so that a speech recognition engine specified at step 5052 can recognize voice data. At that time, the system is so set that the voice data is transmitted from the service requesting apparatus 300C to the speech recognition engine owned by the service providing apparatus 200A.

It should be noted that a speech recognition engine to be used need not necessarily be one owned by a service providing apparatus which provides a required service. For example, the service providing apparatus 200D can provide speech recognition service, and therefore can be used as a speech recognition engine for another service providing apparatus. Furthermore, a service providing apparatus dedicated for speech recognition can also be used to recognize the voice data. A table used for specifying a target speech recognition engine need not necessarily specify a speech recognition engine for each service providing apparatus. For example, a plurality of speech recognition engines and their priorities may be registered in the table. And if a specified service providing apparatus has a speech recognition engine, that speech recognition engine is used. Otherwise, a speech recognition engine in a field related to the service to be provided by the specified service providing apparatus is searched for on the network using the table. If no suitable speech recognition engine is found in the search, it may be arranged such that a speech recognition engine owned by the service mediating apparatus 100 is used.

At step 507, the speech recognition engine owned by the service providing apparatus 200A recognizes a request (voice data) from the service requesting apparatus 300C. At step 508, the service providing apparatus 200A performs information processing for providing a service requested by the user based on the recognition results of the voice data. For example, if the user has entered the request message “I want to see a menu”, the service providing apparatus 200A outputs menu data held by the apparatus to the service requesting apparatus 300C through the network 1 based on the recognition results by the speech recognition engine, at step 508. The service requesting apparatus 300C then outputs the menu onto the screen of the indicator 306 and/or reads out the menu from the speaker 305.

A speech recognition engine owned by an apparatus other than a specified service providing apparatus may be used to recognize voice data as described above. It should be noted that reception of service and information at step 509 may be carried out through the service mediating apparatus 100.

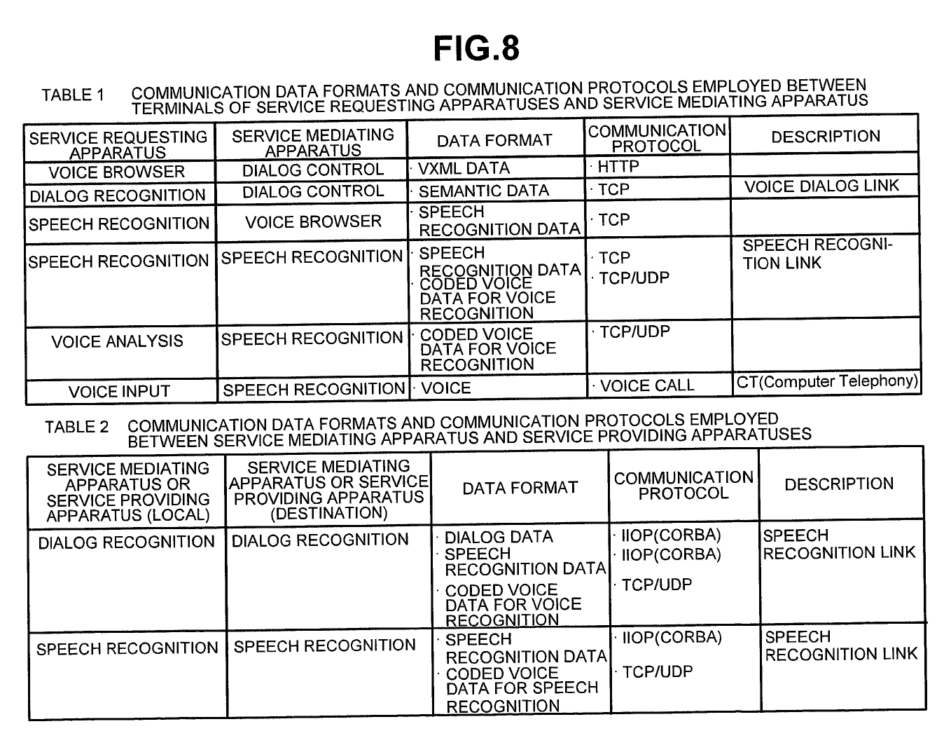

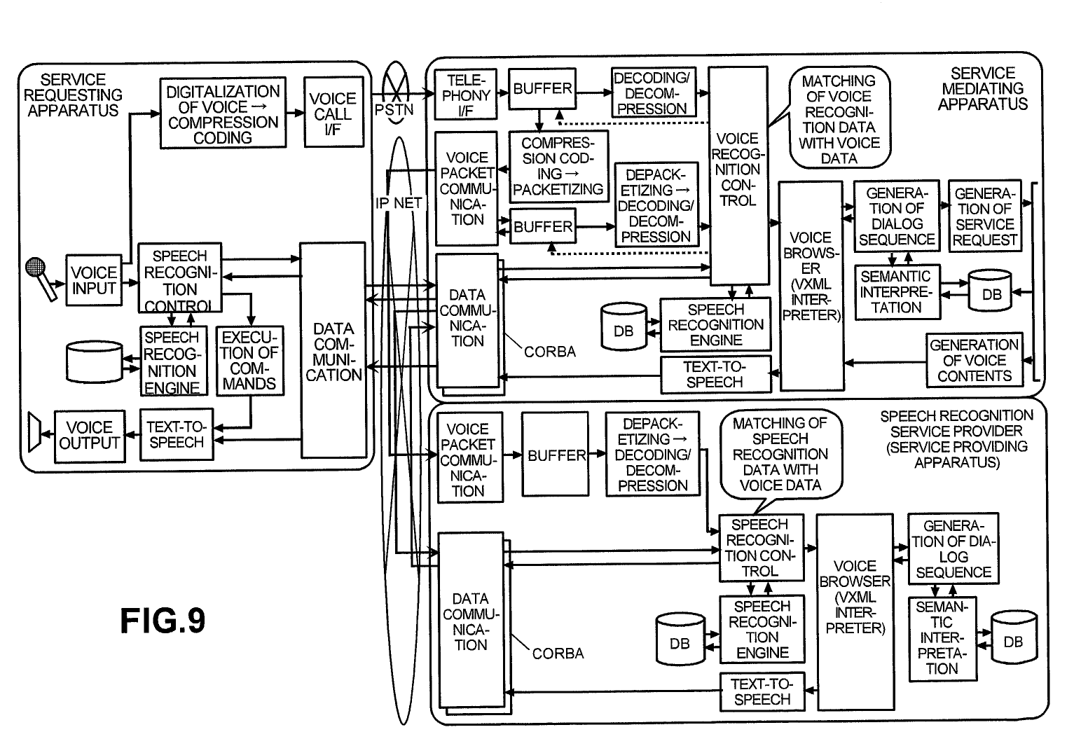

FIG. 8 shows an example of communication protocols used between the apparatuses according to the present embodiment. FIG. 9 shows a configuration of a system using the communication protocols in FIG. 8. It should be noted that data formats used between communicating apparatuses may be different depending on each communicating apparatus. Specifically, a data format meeting the function of each transmission destination apparatus may be used. For example, the service requesting apparatus 300A may use a text format while the service requesting apparatus 300E may use voice data itself.

The service requesting apparatus of the present embodiment includes only a text-to-speech program and a speech recognition engine. However, either a dialog organization program or a voice browser may be added to the service requesting apparatus to process a dialog with the user. On the other hand, the service requesting apparatus may have only a voice input/output function and include no program for processing dialogs. A voice analysis program may be added to the service requesting apparatus to analyze voice.

Further, one of the information/service providing program, the dialog organization program, and the voice browser can be omitted from the configuration of the service requesting apparatus 200A. For example, at least one of them can be omitted from the service requesting apparatuses 200C and 200D, which provide speech recognition service. Furthermore, some service providing apparatuses do not require any speech recognition engine. For example, no speech recognition engine may be included in the service providing apparatus 200B, which provides restaurant information. In this case, the service providing apparatus 200B searches restaurant information using voice data recognized with a speech recognition engine specified by the service mediating apparatus 100, and provides information obtained as a result of the search.

The service requesting apparatuses 300A through 300C may use dictionaries in remote locations through the network 1 to recognize a voice. In such a case, the frequency of use of each dictionary may be stored so that dictionaries whose use is more frequent than a predetermined number of times may be downloaded or cached.

The present invention may be configured such that when a speech recognition operation fails, the system may automatically switch to a human operator for recognizing the voice. In FIG. 1, for example, the service providing apparatus 200A may include a human operator, and if its speech recognition engine fails to recognize a voice, the service providing apparatus 200A automatically switches to the operator to respond to the voice.

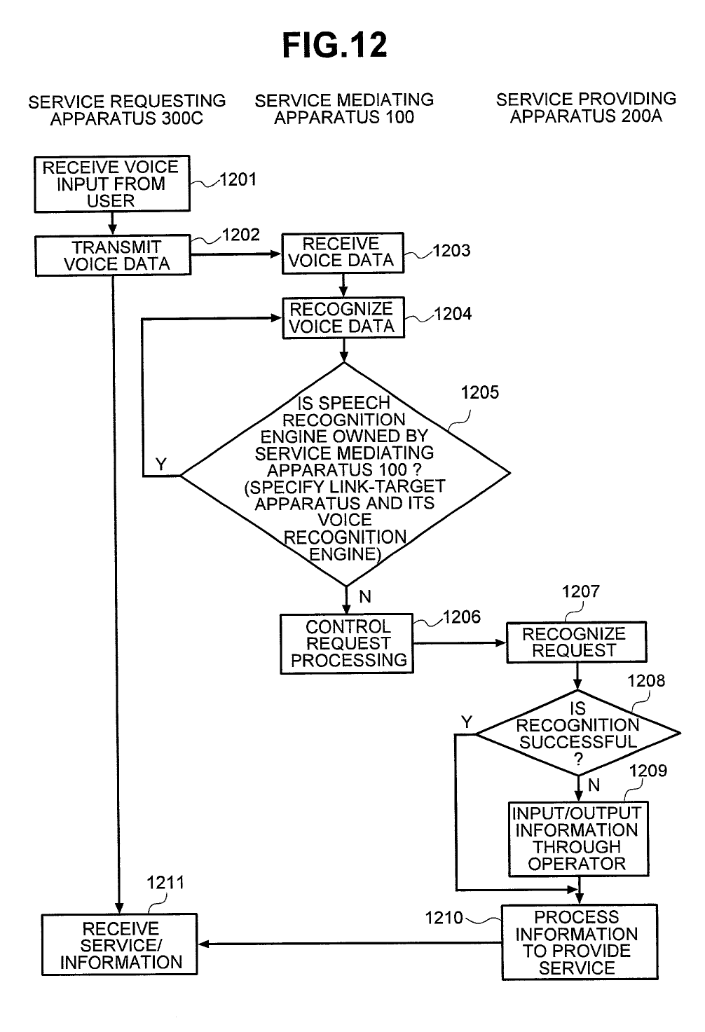

FIG. 12 is a flowchart showing the process of switching to an operator when a speech recognition operation fails. At step 1207, the service providing apparatus 200A starts to recognize a request. If the service providing apparatus 200A fails to recognize the request (branch N of step 1208), the apparatus connects the service requesting apparatus 300C to the operator so that the operator can request an input from the user through a dialog between the user and the operator at step 1209. After recognizing the request, the service providing apparatus 200A carries out processing necessary for providing service at step 1210, and sends the requested service/information to the service requesting apparatus 300C at step 1211.

Voice subjected to speech recognition may always be recorded for a predetermined period of time, and if a speech recognition operation fails, the recorded voice data and the speech recognition results obtained until then may be supplied to the operator. With this arrangement, the operator can listen to the previous dialogs and refer to the speech recognition results so as to quickly understand what has been requested or spoken without listening to the actual conversation between the user and the service providing apparatus all the time, making it possible to smoothly switch to the operator for responding to inputs.

It should be noted that even though the above description of the present embodiment assumes that the operator is included in the service providing apparatus, it may be the service mediating apparatus that includes the operator instead.

As described above, the present invention includes provision of various services in addition to restaurant search service, input of various types of input data, and various systems in which apparatuses of the present invention are installed. For example, the present invention includes image, text, etc. as input data in addition to voice. And as systems, the present invention includes computers in homes, mobile computers, and portable phones, in addition to vehicles having an apparatus of the present invention mounted thereon.

The present invention includes various modes for the service providing apparatus in addition to that of the service providing apparatus 200A, and each service providing apparatus carries out processing according to its function. For example, a service providing apparatus which does not have a speech recognition engine performs information processing for providing service using recognition results provided by a speech recognition engine of another apparatus. Similarly, the present invention also includes various modes for the service requesting apparatus in addition to that of the service requesting apparatus 300C, and each service requesting apparatus carries out processing according to its function. For example, the service requesting apparatus 300A performs speech recognition and processing of a dialog with the user within its functional capability.

The present invention makes it possible to quickly and accurately recognize service requests on a network. Accordingly, it is possible to efficiently provide a requested service.

What is claimed is:

1. A service providing system, comprising:
at least one service providing apparatus for processing information to provide a service,
at least one service requesting apparatus for processing information to request the service from the service providing apparatus, and
at least one service mediating apparatus connected to the service providing apparatus and the service requesting apparatus via a network,
wherein the service requesting apparatus receives a voice input indicating an instruction as to a service requested by a user of the service requesting apparatus,
the service mediating apparatus specifies a service providing apparatus which is to perform a process corresponding to the instruction,
based on the specified service providing apparatus, the service mediating apparatus specifies an information processing apparatus which is to recognize a voice input from the user, and
the specified service providing apparatus processes information to provide a service based on speech recognition performed by the specified information processing apparatus.

2. The system of claim 1, wherein the service mediating apparatus specifies the information processing apparatus based on information indicating a corresponding relationship between the specified service providing apparatus and the information processing apparatus which is to recognize the voice.

3. The system of claim 2, wherein the service mediating apparatus includes a storage device for storing the information indicating the corresponding relationship between the specified service providing apparatus and the information processing apparatus which is to recognize the voice.

4. The system of claim 3, wherein the corresponding relationship is described by a voice extended markup language.

5. The system of claim 4, wherein information described by the voice extended markup language includes information specifying an execution condition for recognizing a voice.

6. The system of claim 1, wherein the information processing apparatus which is to recognize the voice is connected to the network.

7. The system of claim 1, wherein the service requesting apparatus is an information processing apparatus usable in a moving vehicle.

8. A service mediating apparatus connected via a network to at least one service providing apparatus for processing information to provide service, and at least one service requesting apparatus for processing information to request the service from the service providing apparatus, the service mediating apparatus comprising:
means for receiving, via the network, a voice input indicating an instruction as to a service requested by a user of the service requesting apparatus, the voice input having been received by the service requesting apparatus,
means for specifying a service providing apparatus which is to perform a process corresponding to the instruction, and
means for specifying an information processing apparatus which is to recognize a voice input from the user based on the specified service providing apparatus, wherein the specified service providing apparatus processes information to provide a service based on speech recognition performed by the specified information processing apparatus.

9. The apparatus of claim 8, wherein the means for specifying an information processing apparatus specifies the information processing apparatus based on information indicating a corresponding relationship between the specified service providing apparatus and the information processing apparatus which is to recognize the voice.

10. The apparatus of claim 9, comprising:
a storage device for storing the information indicating the corresponding relationship between the specified service providing apparatus and the information processing apparatus which is to recognize the voice.

11. The apparatus of claim 8, wherein the corresponding relationship is described by a voice extended markup language.

12. The apparatus of claim 11, wherein information described by the voice extended markup language includes information specifying an execution condition for recognizing a voice.

13. The apparatus of claim 10, comprising:
means for connecting, via the network, with the information processing apparatus which is to recognize the voice.

14. A service mediating apparatus for processing information to mediate a service, the service mediating apparatus comprising:
a receiving device for receiving user voice information indicating an instruction as to a service requested by a user of a service requesting apparatus,
a storage device for storing a program for specifying a service corresponding to an instruction indicated by the voice information and, based on the specified service, specifying a speech recognition program for recognizing the voice information,
a processing device for, according to the program, specifying the service corresponding to the instruction indicated by the user voice information and, based on the specified service, specifying a speech recognition program which is to recognize the user voice information, the processing device being connected to the receiving device and the storage device, and
an output device for outputting information for recognizing the user voice information to an information processing apparatus which is to recognize a voice according to the specified speech recognition program.

15. The apparatus of claim 14, comprising:
an additional storage device for indicating a corresponding relationship between the service and the speech recognition program,
wherein the processing device specifies the speech recognition program using the additional storage device.

16. The apparatus of claim 13, wherein the corresponding relationship is described by a voice extended markup language.

17. The apparatus of claim 14, wherein the apparatus connects with the information processing apparatus having a speech recognition engine via a network.

18. The apparatus of claim 14, wherein the storage device holds a speech recognition program, and the processing device recognizes the user voice information using the speech recognition program held by the storage device.

19. The apparatus of claim 14, wherein the receiving device is connectable to a service requesting apparatus through a network to receive the user voice information from the service requesting apparatus through the network.
